(19) United States
(12) Patent Application Publication
(10) Pub. No.: US 2010/0179965 A1
(43) Pub. Date: Jul. 15, 2010

(54) IMAGE PROCESSING APPARATUS AND IMAGE PROCESSING METHOD

(75) Inventor: Motoki Koshigaya, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/685,184

(22) Filed: Jan. 11, 2010

(30) Foreign Application Priority Data
Jan. 13, 2009 (JP) 2009-004329

(51) Int. Cl. G06F 12/14; G06F 17/30

(52) U.S. Cl. 707/783; 707/E17.005

(57) ABSTRACT

The present invention is directed to an image processing apparatus which can change the access authority for a folder based on the restricted functions for each user, even if the user operates a folder which a restricted function is associated with. When an operation on a hot folder is received from a user, the present invention determines whether that user has an access authority for the hot folder. If it is determined that the user does have an access authority, it is further determined whether there are any functions which the operating user cannot use among the functions associated with the hot folder. If it is determined that there is/are function (s) which the user cannot use, the access authority for that hot folder is changed, and an error message to that effect is sent to the user.

### BACKGROUND OF THE INVENTION

1. Field of the Invention

The present invention relates to an image processing apparatus which executes function processes associated with a folder.

2. Description of the Related Art

Office equipment such as printers, facsimiles, copying machines, and multifunction peripherals which house these devices in a single casing are now frequently utilized at the workplace. Recently, the processing power of hardware has improved due to advances in technology, so that it is now possible for a multifunction peripheral to provide various functions. For example, an end user can not only now use a multifunction peripheral to individually execute the various functions of a copying machine, printer, image scanner, facsimile, data storage device and the like, but can also realize a function which is executed as a function flow.

The term “function flow” refers to a flow defined by a combination of the respective functions of the printer, facsimile, copying machine, data storage device and the like. By enabling the individual functions of the multifunction peripheral to be executed at one go as a function flow unit, the user can operate and execute processes which used to be individually operated at one go.

To easily perform this function, a storage area (hereinafter, “hot folder”) with which the function for executing the function flow is associated may be provided in a file sharing function of the multifunction peripheral. This file sharing function of the multifunction peripheral may be, for example, a box function for storing an acquired document in a printer, facsimile, copying machine, or image processing apparatus including these functions, which is connected to a network.

Consequently, the function for executing the function flow can also be realized by performing an operation, such as registration or change, on the file/data in the hot folder.

As an example, an environment is assumed where a plurality of information terminals, such as a personal computer (PC), and a plurality of multifunction peripherals are connected on a network.

Due to the realization of the hot folder by the multifunction peripheral, the user can start the function flow by performing an operation such as registering file/data in the hot folder of the multifunction peripheral.

Consequently, the user can easily execute processes such as printing, copying, and sending mail by organically combining the respective functions of the multifunction peripheral.

However, although the function flow can thus be easily realized, in some cases the functions which can be selected by the user are restricted for security reasons and the like.

For example, a certain user may be permitted to print and copy, but not be permitted to send mail.

In such a case, if a file/data operation is performed on a hot folder which executes a function flow that includes sending mail, the hot folder process is automatically performed on the file/data in the folder.

More specifically, the hot folder cannot appropriately determine the authority of the executing user. Therefore, if a process is set as a hot folder process even when the user lacks the authority to use that process, a function can be used by a user who lacks such authority.

When controlling the functions which can be used by the user in this way, the access control of the multifunction peripheral and the access authority to the hot folder are not simultaneously managed. Therefore, there is a need to control access to the hot folder based on the function authority which the user can use.

For example, Japanese Patent Application Laid-Open No. 2003-266809 discusses a system in which all operations can be performed from a computer on all documents and folders which are stored in a printer controller.

Further, since the stored documents can be utilized without distinguishing between users, this security system resolves the drawback of insufficient protection and management of the stored documents and folders.

An example of the flow of the function processing performed by this system will be described below.

An operation to print, delete or the like a document stored on the printer controller is requested from the computer which is directly, or indirectly via a network, connected to a printer.

Then, using a management table held by a document or folder management unit, a search is performed as to the operation authority of the user who makes the operation request with respect to the document or folder. Based on the search result, it is determined whether the user has permission to perform an operation on the document or folder. The result is sent back to the operation request source, whereby the document or folder on the printer controller is protected.

However, even for a system which controls the functions used by a user, there are still cases where a process which the user lacks the authority to use is executed as a hot folder process. This is because the hot folder functions and the restricted functions of the user are not managed in a coordinated manner. Therefore, if the access authority for the user using the hot folder is set to be free in the initial setting, the user can execute all the functions set in the hot folder as a user who is not under access control.

In such a situation, if the access authority for the folder is to be set or changed for each user, the greater the number of users using the image processing apparatus, the greater the burden that is placed on the system administrator.

### SUMMARY OF THE INVENTION

The present invention is directed to an image processing apparatus which can change the access authority for a folder based on the restricted functions for each user, even if the user operates a folder which a restricted function is associated with.

According to a first aspect of the present invention, an image processing apparatus configured to manage a folder with which a function process to be executed using any of a plurality of function processing units is associated, including an access control management unit configured to manage a restricted function process for which usage is restricted, for each user, among function processes performed by the plurality of function processing units, an authority management unit configured to manage an access authority set in the folder for each user, a change unit configured to, when a file operation on the folder is performed by a user, compare the function process associated with the folder and the restricted function process of an identified user, and change the access authority managed by the authority management unit to match the restricted function process, and a control unit configured to control a request of the file operation based on the access authority managed by the authority management unit when a file operation is received for the folder from the user.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of an image processing system according to a first exemplary embodiment.

FIG. 2 illustrates an example of a user interface of the image processing system illustrated in FIG. 1.

FIG. 3 is a block diagram illustrating a configuration of the PCs illustrated in FIG. 1.

FIG. 4 is a block diagram illustrating a configuration of the image processing apparatuses illustrated in FIG. 1.

FIG. 5 is a block diagram illustrating a module configuration of the image processing apparatus illustrated in FIG. 4.

FIG. 6 is a flowchart illustrating an example of a data processing order in the image processing apparatus according to the first exemplary embodiment.

FIG. 7 illustrates an access authority state of a hot folder managed by the image processing apparatus according to the first exemplary embodiment

FIG. 8 illustrates an access authority state of a hot folder managed by the image processing apparatus according to the first exemplary embodiment.

FIG. 9 is a flowchart illustrating an example of a data processing order in the image processing apparatus according to a second exemplary embodiment.

FIG. 10 illustrates an access authority state of a hot folder managed by the image processing apparatus according to the second exemplary embodiment.

FIG. 11 illustrates an access authority state of a hot folder managed by the image processing apparatus according to the second exemplary embodiment.

FIG. 12 illustrates an access authority state of a hot folder managed by the image processing apparatus according to a third exemplary embodiment.

FIG. 13 illustrates an access authority state of a hot folder managed by the image processing apparatus according to the third exemplary embodiment.

FIG. 14 illustrates a memory map of a storage medium storing various data processing programs which can be read by the image processing apparatus according to the present invention.

### DESCRIPTION OF THE EMBODIMENTS

Various exemplary embodiments, features, and aspects of the invention will be described in detail below with reference to the drawings.

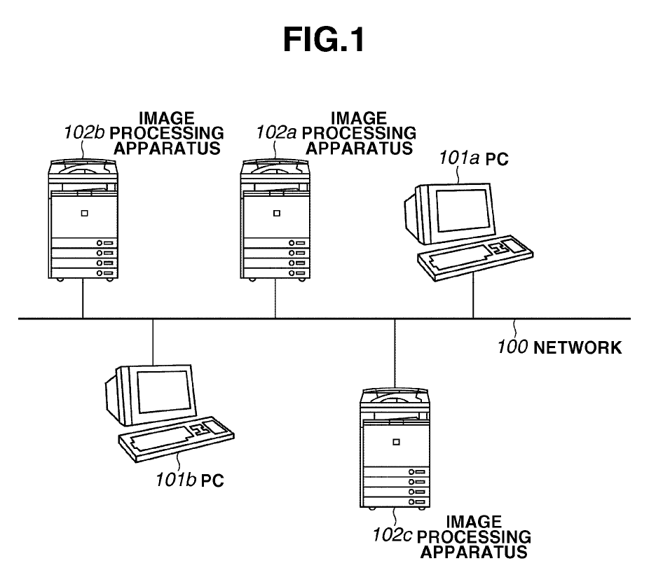

FIG. 1 illustrates an example of an image processing system according to a first exemplary embodiment. In the present system, a plurality of PCs 101a and 101b are connected via a network 100 to a plurality of image processing apparatuses 102a, 102b, and 102c. This system includes an access control (AC) function. AC is a function which allows the administrator to manage the function processes of which usage is restricted on an individual user basis, among the function processes that the image processing apparatus can execute. AC is managed as a table in a storage device included in the image processing apparatus. Therefore, a control unit of the image processing apparatus identifies the user, and if the control unit determines that the processing function selected by that user matches a restricted function registered in the table, the control unit performs control so that that function processing is not executed.

Examples of the main functions of the AC include control of the number of sheets which can be printed by each user, a color/monochrome forcible control, a forcible two-sided printing control to save printing paper, a forcible N-Up control, data transfer function and the like. The “data transfer function” (SEND) can also be associated with the below-described hot folder. More specifically, the image processing apparatus according to the present exemplary embodiment is configured so that the function processes can be associated on a per-folder basis. The folder for executing such a function process is called a hot folder (HF). When a file (e.g. a document etc.) is added into (registered in) the hot folder (HF), the process (function) associated with the folder is performed on the file.

Examples of functions which can be associated with the hot folder include the functions included in the image processing apparatus, a print function, a scan function, and a data transfer function. For example, if the data transfer function is associated with the HF, a data transfer destination is preset for the data transfer setting in the HF. This data transfer destination setting in the HF is, in the case of sending mail, a mail address, and in the case of server message back (SMB), a file-sharing folder path. When a file (document) is added into this HF, that document is sent to the data transfer destination set in the HF.

When a request for a file operation, for example to register, change, or delete a document, is detected, the HF according to the present invention controls access to the hot folder using access control information which is managed on a per-user basis.

In FIG. 1, the network 100 may be an arbitrary network system, such as the Internet, an intranet and the like.

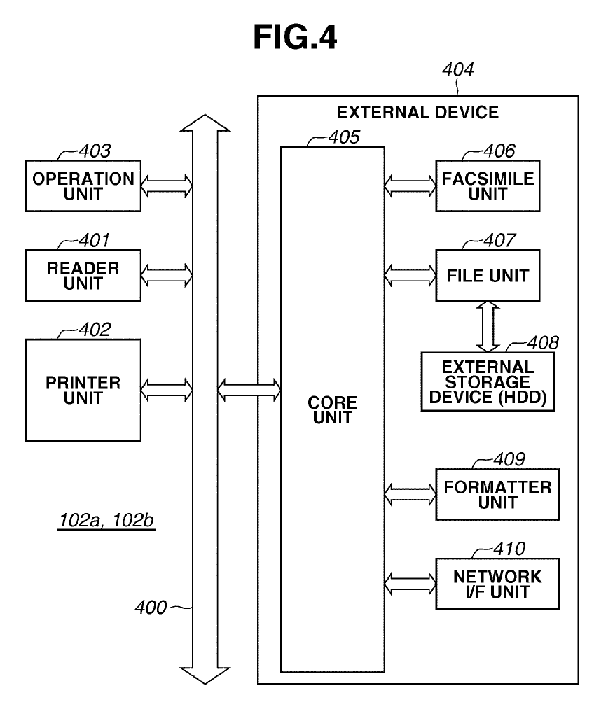

Further, the image processing apparatuses 102a to 102c include the hardware resources illustrated in the below-described FIG. 4, and the software resources for controlling those hardware resources.

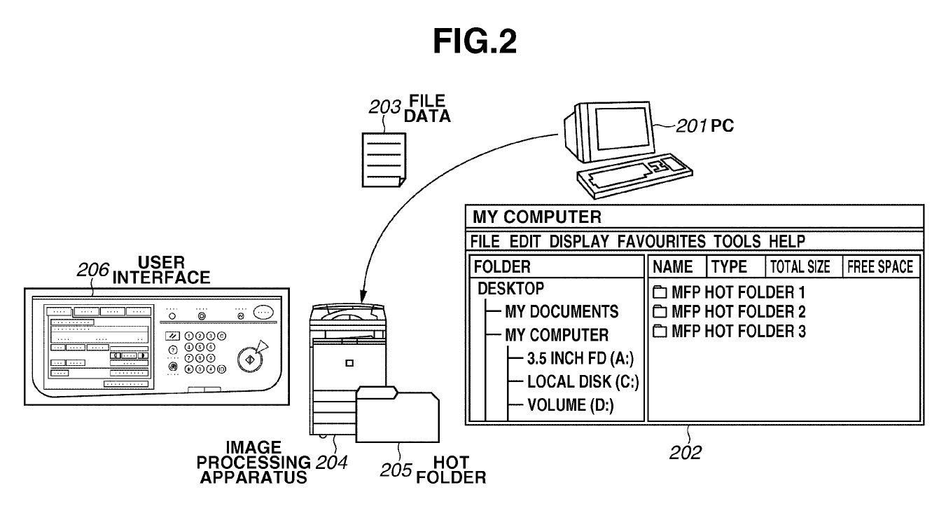

FIG. 2 illustrates an example of a user interface of the image processing system illustrated in FIG. 1. This example illustrates a case where the hot folder function of an image processing apparatus 204 is utilized using a browser on a PC 201, and the hot folder function is utilized using an operation unit of the image processing apparatus 204. The PC 201 and the image processing apparatus 204 are connected in a configuration similar to that illustrated in FIG. 1. Further, in FIG. 2, the image processing apparatus is a multifunction peripheral (MFP). This MFP includes a storage device, such as a hard disk, which enables the function as the hot folder (HF).

In FIG. 2, a user interface (UI) 202 provides a browser which is managed by an operating system of the PC 201. The user operates the UI 202 to perform the processing for registering a created file or data 203 in a hot folder 205 of the image processing apparatus 204.

In the UI 202, the hot folder of the MFP corresponds to the hot folder 205 of the image processing apparatus 204. Instead of the PC 201 having a browser, the operation for adding the file/data 203 into the hot folder 205 may also be performed using dedicated utility software.

More specifically, the user can perform operations such as registering the file/data 203 in the hot folder 205 by utilizing the hot folder function through direct operation using a UI 206 of the image processing apparatus 204.

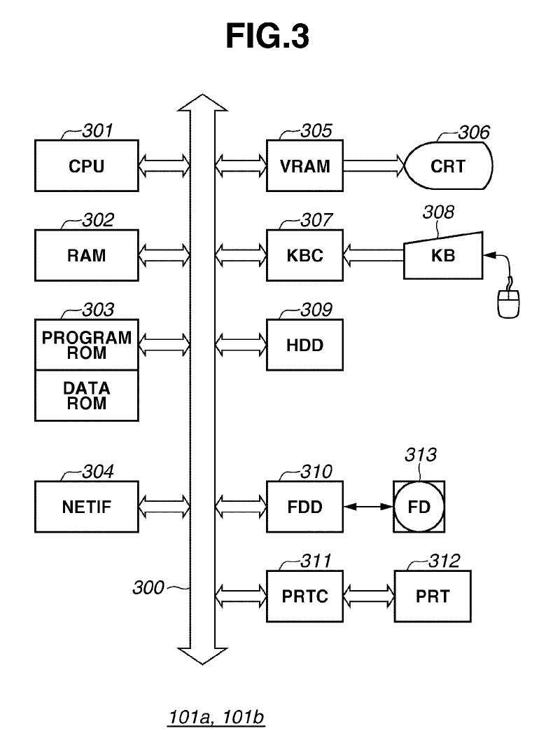

FIG. 3 is a block diagram illustrating a configuration of the PCs 101a and 101b illustrated in FIG. 1.

In FIG. 3, a central processing unit (hereinafter, “CPU”) 301 performs calculations and controls. A random access memory (hereinafter, “RAM”) 302 functions as a main memory of the CPU 301, and as a work area and a data area of an executed program.

A read only memory (hereinafter, “ROM”) 303 stores operation procedures of the CPU 301. The ROM 303 includes a program ROM in which a basic software (OS), which is a system program for performing device control of the information terminal, is recorded. The ROM 303 also includes a data ROM in which information and the like necessary to run the system is recorded. Depending on the system, a below-described HDD 309 may also be used instead of the ROM 303.

A network interface (hereinafter, “NET IF”) 304 controls data transfer between the information terminals via a network and diagnoses the connection state.

A video RAM (hereinafter, “VRAM”) 305 rasterizes an image for display on a screen of a display apparatus (hereinafter, “CRT”) 306 which shows the operating state of the below-described information terminals, and controls that display. A controller (hereinafter, “KBC”) 307 controls an input signal from an external input device (hereinafter, “KB”) 308.

The KB 308 receives an operation made by the user. As the KB 308, a keyboard or a pointing device such as a mouse may be used, for example.

A hard disk drive (hereinafter, “HDD”) 309 is used for storage of application programs and various data.

Examples of the application programs in the present exemplary embodiment include a software program for executing the various processing units according to the present exemplary embodiment.

An external input/output device (hereinafter, “FDD”) 310 is configured by a removable disk such as a floppy disk or a compact disc-(CD) ROM drive. The FDD 310 is used for reading the above-described application program from a medium.

A data recording device (removable media) 313 is configured by a magnetic recording medium, optical recording medium, magneto-optical recording medium, semiconductor recording medium or the like, which is read from by the FDD 310. The data recording device 313 can be removed from the FDD 310. Examples of magnetic recording media include a floppy disk and an external hard disk. Examples of optical recording media include a CD-ROM. Examples of magneto-optical recording media include a MO disk. Examples of semiconductor recording media include a memory card.

The application program and the data to be registered in the HDD 309 may also be used by registering them in the FDD 310.

A controller (hereinafter, “PRTC”) 311 controls an output signal to a printing apparatus (hereinafter, “PRT”) 312. The PRT 312 may be, for example, a laser beam printer (LBP).

A transmission bus 300 connects each of the above-described units with each other. The transmission bus 300 is configured from an address bus, a data bus, an input/output bus, and a control bus.

FIG. 4 is a block diagram illustrating a configuration of the image processing apparatuses 102a and 102b illustrated in FIG. 1. FIG. 4 illustrates a case where the image processing apparatuses are configured by an MFP as described above. The MFP includes a print function processing unit, a scan function processing unit, a data transfer function processing unit, a file management function processing unit and the like as a plurality of function processing units. The function processes which use the print function processing unit and the scan function processing unit serve as a copy function process. The file management function processing unit manages a below-described folder area set in the HDD and a BOX area set by the user. Further, the file management function processing unit executes the function processes associated with the hot folder. The hot folder may act as a single function or act as a coordinated function which coordinates the processing using a plurality of hot folders.

In FIG. 4, an image input device (hereinafter, “reader unit”) 401 is a unit for converting an original into image data. The reader unit 401 photoelectrically reads (scans) an original image by a charge-coupled device (CCD) linear image sensor or the like, converts the read original image into digital image data, and outputs the converted digital image data.

An image output unit (hereinafter, “printer unit”) 402 has a plurality of kinds of recording paper cassettes. Image data from the reader unit 401 is output as a visible image onto recording paper based on a print command input by the reader unit 401.

An operation unit (operation panel) 403 instructs the reader unit 401 to convert the original into image data. The operation unit 403 also sends a processing instruction to the external device 404 which is electrically connected to the reader unit 401.

The external device 404 includes a core unit 405, a facsimile unit 406, a file unit 407, an external storage device (HDD) 408 connected to the file unit 407, a formatter unit 409, and a network interface unit 410.

The various constituent elements of the external device 404 realize the following respective functions.

The core unit 405 performs input/output control of the commands or status management of the various constituent elements of the external device 404, and image data input/output control. The facsimile unit 406 performs facsimile function control.

The file unit 407 performs file/system function control for managing the files stored in the external storage device 408. The formatter unit 409 performs processing for making the image data information a visible image.

The network interface unit 410 is connected to the network, and performs communication processing.

A transmission bus 400 connects the reader unit 401, the printer unit 402, the operation unit 403, and the external device 404. The transmission bus 400 is configured from an address bus, a data bus, an input/output bus, and a control bus.

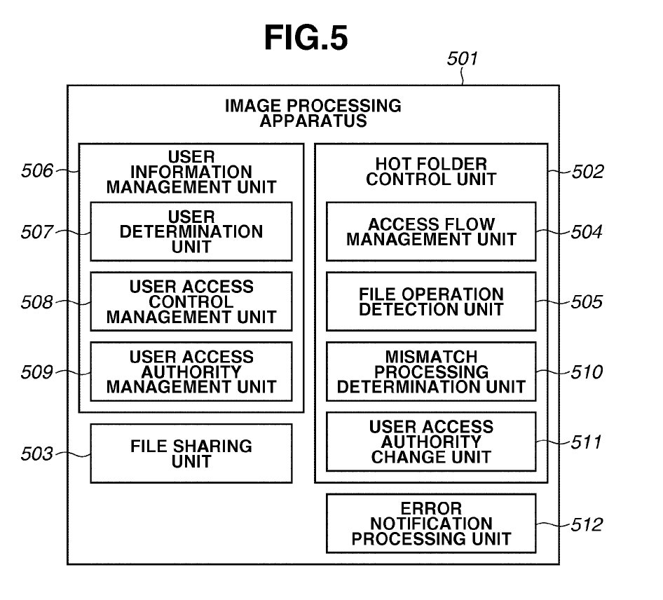

FIG. 5 is a block diagram illustrating a module configuration of the image processing apparatus configuration illustrated in FIG. 4.

In FIG. 5, a hot folder control unit 502 controls the various functions relating to the hot folder. These various functions relating to the hot folder will be described below.

A file sharing unit 503 opens the hot folder as a storage area which can be shared by the PCs connected to the network by utilizing a versatile protocol. Due to the file sharing unit 503, the file/data can be registered in the hot folder by utilizing a versatile application/software from the PC.

The term “versatile application/software” means a software program which supports a versatile protocol which is included in the browser of the operating system or the like.

A function flow management unit 504 realizes the following functions. A first function is to register the file/data sent to the hot folder released by the file sharing unit 503. This first function is triggered by the registration of the file/data to start the pre-registered function flow.

A file operation detection unit 505 detects what kind of operation was performed (e.g., file/data registration, deletion etc.) when the user performed some kind of operation on the hot folder.

A user information management unit 506 manages user information such as the user access authority and the access controls, and controls the unit which handles user information. This corresponds to the AC function. A user determination unit 507 determines and specifies the executing user based on information about the user managed in the user information management unit 506 when the file operation detection unit 505 detects a hot folder operation.

A user access control management unit 508 manages the access controls for each user of the image processing apparatus based on the user access control function. A user access authority management unit 509 manages the access authorities for the folders and files for each user. Further, the user access control management unit 508 and the user access authority management unit 509 can be changed by the administrator.

However, the system is configured such that an access authority is automatically set based on the below-described processing according to the present invention even if the access authority is not set.

Further, the user information management unit 506, which includes the user determination unit 507, the user access control management unit 508, and the user access authority management unit 509, may be managed as an individual image processing apparatus or as a sever system.

A mismatch processing determination unit 510 receives information about the function flow management unit 504 and the user access control management unit 508 for the user determined by the user determination unit 507. Further, the mismatch processing determination unit 510 confirms and determines whether there are any problems with the access authority of the user in processing the function flow to be executed in response to the operation detected by the file operation detection unit 505.

A user access authority change unit 511 changes the access authority of the process for which there was a mismatch in the user access authority management unit 509, when the mismatch processing determination unit 510 determines that there was a mismatch in the processing.

An error notification processing unit 512 notifies the user when the access authority of the user is changed and an error occurs in the processing of the function flow. Further, the error notification processing unit 512 also receives error messages from other coordinated image processing apparatuses, and notifies the user when such an error message is received.

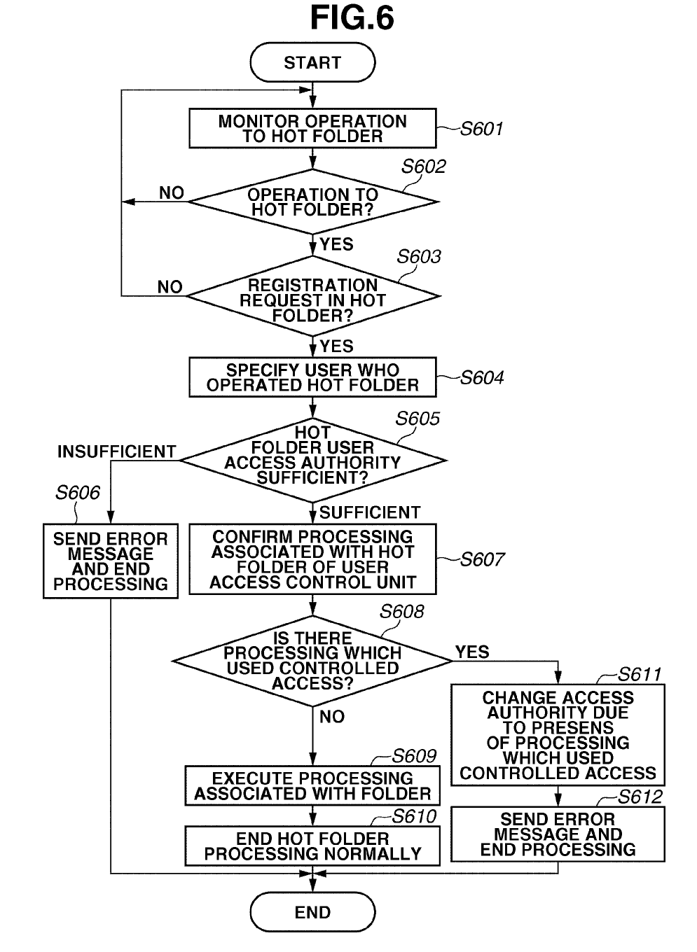

FIG. 6 is a flowchart illustrating an example of a data processing procedure in the image processing apparatus according to the present exemplary embodiment. FIG. 6 illustrates an example of processing when a given user A performs an operation on a hot folder HF. Steps S601 to 612 represent the respective steps which are performed. Each of these steps is realized by the CPU in the core unit 405, which loads a control program into the RAM and executes the loaded program.

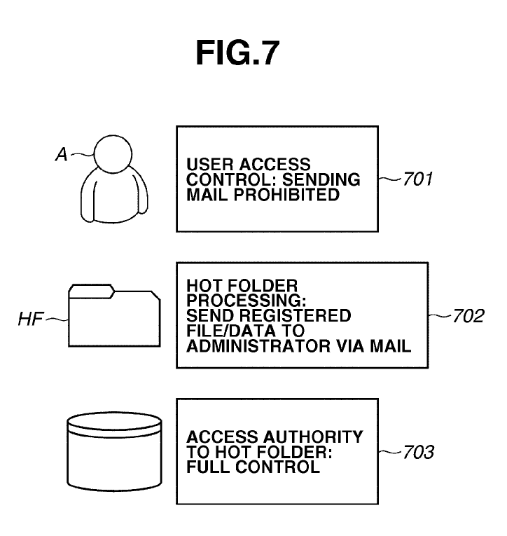

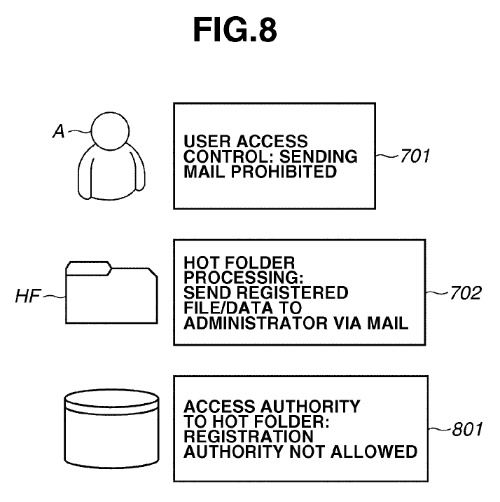

FIGS. 7 and 8 illustrate an access authority state of the hot folder managed by the image processing apparatus according to the present exemplary embodiment. FIGS. 7 and 8 illustrate a given user A, a hot folder HF, and an example of setting of the access authority to the hot folder HF. FIG. 7 corresponds to the state before the access authority is rewritten. FIG. 8 corresponds to the state after the access authority for user A has been changed.

In FIG. 7, a user access control 701 is set for user A. A hot folder process 702 is associated with the hot folder HF to be used here. Further, an access authority 703 for the hot folder HF is set to full control without any particular prohibitions.

The hot folder process 702 is managed in the function flow management unit 504 of FIG. 5 of the hot folder HF, and the access authority 703 for the hot folder HF is managed in the user access authority management unit 509.

An example will now be described in which each image processing apparatus is managed individually. However, the management of the respective image processing apparatuses may also be performed in an integrated manner with an external server. Moreover, management of the respective image processing apparatuses may be performed in a shared manner with a separate image processing apparatus connected via a communication unit such as a network.

In step S601, the hot folder is in a standby state, where the core unit 405 monitors information about an operation of the user made to the hot folder HF. Next, in step S602, the core unit 405 determines whether an operation was performed on the hot folder HF. If no operation was performed (“NO” in step S602), the hot folder remains in a standby state.

As illustrated in FIG. 2, an operation to the hot folder HF, such as registering the file/data in the hot folder HF from the UI 202 on the PC, may be performed. Similarly, an operation of registering the file/data in the hot folder HF may be performed using the UI 206 of the image processing apparatus.

Next, in step S603, if an operation was performed on the hot folder HF by either of the above-described methods (“YES” in step S602), the file operation detection unit 505 detects what kind of operation was requested. In the present exemplary embodiment, file/data registration is performed. If the file operation detection unit 505 detects that there was an operation request for registration in the hot folder HF (“YES” in step S603), the processing proceeds to step S604. If no request is detected (“NO” in step S603), the processing returns to step S601.

In step S604, the user determination unit 507 specifies the user who operated the hot folder HF based on information from the operation request. More specifically, the user determination unit 507 determines who performed the operation by checking information corresponding to the user who performed the operation.

In step S605, the user access authority management unit 509 determines whether the access authority for the hot folder HF is sufficient. In the present exemplary embodiment, the access authority is the initial state i.e., full control. Therefore, the user access authority management unit 509 determines that the access authority is sufficient (“YES” in step S605), and the processing proceeds to step S607.

On the other hand, if the user access authority management unit 509 determines that the access authority is not sufficient (“NO” in step S605), the processing proceeds to step S606. In step S606, the error notification processing unit 512 sends an error message to the operating user that they lack access authority, and ends the processing. This notification is different depending on the access method. For notification from the PC, the message is sent to the browser. For notification from the operation unit, the error message is displayed on the operation unit.

In step S607, the mismatch processing determination unit 510 confirms the functions in which the user is restricted based on the user access control function and the function to be used by the process associated with the hot folder HF. The mismatch processing determination unit 510 receives from the function flow management unit 504 information about the function to be used by the processing of the function flow associated with the hot folder HF and information about the functions restricted by the user access control management unit 508 based on the user access control function.

Then, in step S608, the mismatch processing determination unit 510 determines whether a mismatch occurs in the information confirmed in step S607. In the present exemplary embodiment, if a file operation was performed on the hot folder by the user, the mismatch processing determination unit 510 compares the function process associated with the hot folder with the restricted function processes of the identified user, and determines whether there is a mismatch. Here, for the user A, the data transfer function (SEND function) is managed as the restricted function process.

In the present exemplary embodiment, a mismatch occurs between the sending mail prohibition of the user access control 701 and the sending mail process of the hot folder process 702. Therefore, the mismatch processing determination unit 510 determines that there is a mismatch (“YES” in step S608).

On the other hand, in step S608, if the mismatch processing determination unit 510 determines that a mismatch does not occur (“NO” in step S608), the processing proceeds to step S609. In step S609, the hot folder control unit 502 controls the function flow management unit 504, and executes the function flow registered in the function flow management unit 504 for the file/data registered in the hot folder HF. Then, in step S610, the hot folder control unit 502 ends the hot folder processing normally, and the present processing is finished.

In step S611, the user access authority change unit 511, which has received information from the mismatch processing determination unit 510 that there is a mismatch, changes the access authority for the hot folder HF.

In the present exemplary embodiment, since the process is to perform sending mail, which the registration access authority prohibits to perform, the user access authority change unit 511 rescinds (changes) the registration access authority. Then, the changed access authority is stored in the user access authority management unit 509.

Next, in step S612, since the hot folder control unit 502 accesses a hot folder for which access authority was rescinded, the error notification processing unit 512 sends an error message to the user to that effect, and ends the present processing.

Thus, in the present exemplary embodiment, while access into the hot folder acts as a trigger, an operation into the hot folder can be prevented by instantly determining the access control and the function flow processing, and changing the access authority. Below, a changed state of the access authority for the hot folder after execution of the processing illustrated in FIG. 6 will be described with reference to FIG. 8.

In the above-described first exemplary embodiment, based on a series of operations according to the function flow illustrated in FIG. 6, an error occurs and the access authority 703 of the hot folder HF is changed to an access authority 801 of the hot folder. This setting is stored in the user access authority management unit 509 of the respective hot folder, and the hot folder control unit 502 prohibits subsequent access to the hot folder HF.

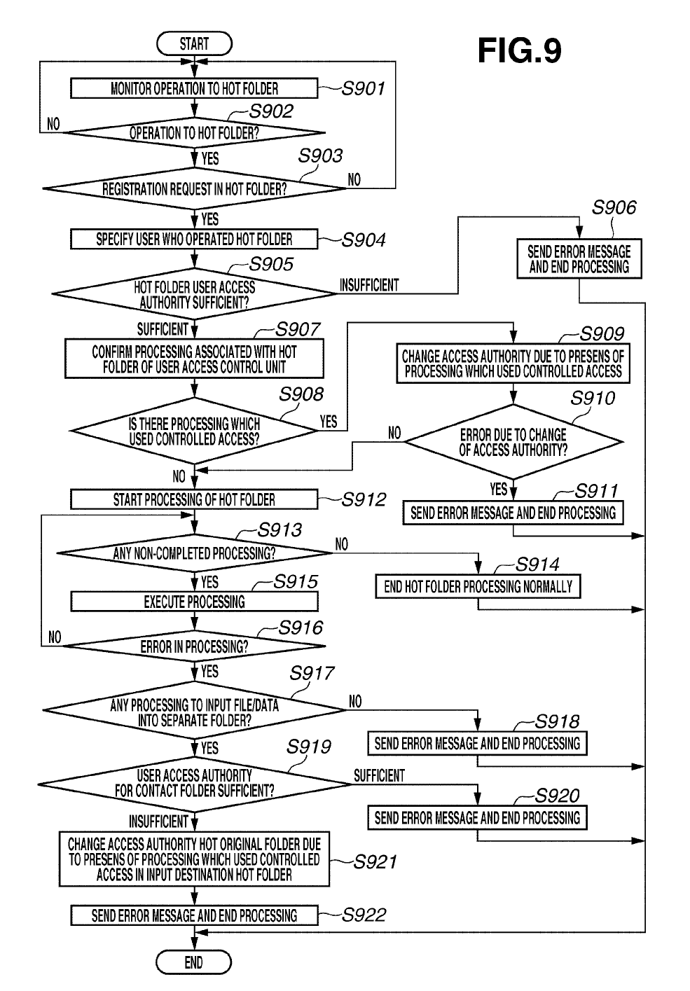

FIG. 9 is a flowchart illustrating an example of a data processing order in the image processing apparatus according to a second exemplary embodiment. FIG. 9 illustrates an example of processing when a given user B performs an operation on the hot folder HF. Steps S901 to 922 represent the respective steps which are performed. Each of these steps is realized by the CPU in the core unit 405, which loads a control program into the RAM and executes the loaded program.

In the present exemplary embodiment, the function flow is coordinated with a hot folder HFB from a hot folder HFA side. This case will be described assuming that there are a hot folder HFA and a hot folder HFB. Further, the hot folder HFA and the hot folder HFB may be present in the same image processing apparatus or in different image processing apparatuses.

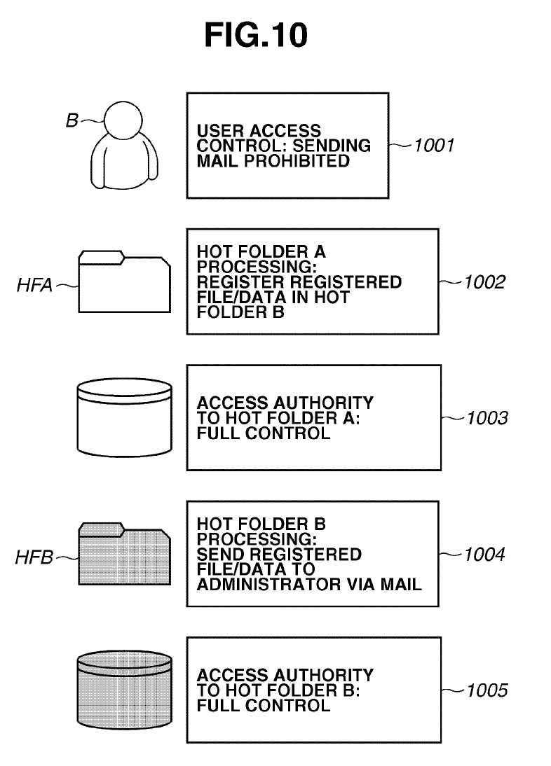

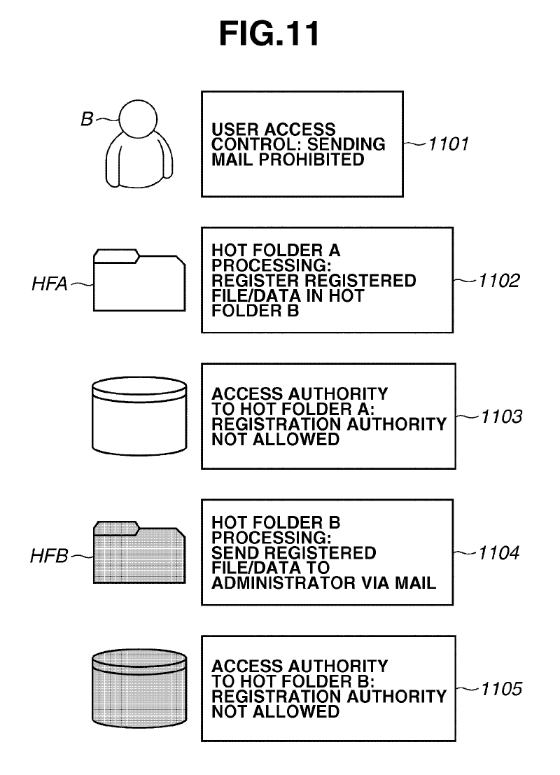

FIGS. 10 and 11 illustrate an access authority state of a hot folder managed by the image processing apparatus according to the present exemplary embodiment. FIGS. 10 and 11 illustrate the set state of a given user B, a hot folder HFA, the access authority for the hot folder HFA, a hot folder HFB, and the access authority for the hot folder HFB. FIG. 10 corresponds to the state before the access authority is rewritten. FIG. 11 corresponds to the state after the access authority for user B has been changed based on the execution illustrated in FIG. 9.

The assumptions of the processing according to the present exemplary embodiment will now be described. In the present exemplary embodiment, user B is set as indicated by a user access control 1001. Further, a process 1002 is associated with the hot folder HFA to be used here, and an access authority 1003 for the hot folder HFA is set to full control without any particular prohibitions.

Similarly, a process 1004 of the hot folder HFB is associated with the hot folder HFB to be used here, and an access authority 1005 for the hot folder HFB is set to full control without any particular prohibitions.

Further, the process 1002 of the hot folder HFA is managed in the function flow management unit 504 illustrated FIG. 5, and the access authority 1003 for the hot folder HFA is managed in the user access authority management unit 509.

Similarly, the process 1004 of the hot folder HFB is managed in the function flow management unit 504, and the access authority 1005 for the hot folder HFB is managed in the user access authority management unit 509. As an example, each image processing apparatus is managed individually. However, the management of the respective image processing apparatuses may also be performed in an integrated manner by connecting an external server to the system. Moreover, management of the respective image processing apparatuses may be performed in a shared manner with a separate image processing apparatus connected via a communication unit such as a network.

In step S901, each of the units restricted by the hot folder control unit 502 is monitored. In the present exemplary embodiment, both the hot folder HFA and the hot folder HFB are in a standby state. Further, both the hot folder HFA and the hot folder HFB monitor an operation from user B.

Next, in step S902, the hot folder control unit 502 determines whether an operation was performed on the hot folder HFA and the hot folder HFB. If no operation was performed (“NO” in step S902), the hot folders remain in a standby state.

In the present exemplary embodiment, as illustrated in FIG. 2, an operation on the hot folder HFA, such as registering the file/data in the hot folder HFA from the UI 202 on the PC, may be performed. Similarly, an operation of registering the file/data in the hot folder HFA by using the UI 206 displayed on the operation unit of the image processing apparatus may be performed.

In step S903, when the hot folder control unit 502 determines that an operation was performed on the hot folder HFA by either of the above-described methods (“YES” in step S902), the file operation detection unit 505 detects what kind of operation was requested. In the present exemplary embodiment, the file operation detection unit 505 detects that there was an operation request for registration of file/data in the hot folder HFA (“YES” in step S903). If no operation request for registration of the file/data is detected (“NO” in step S903), the processing returns to step S901.

Next, in step S904, the user determination unit 507 specifies the user who operated the hot folder, based on information about the operation request. In the present exemplary embodiment, the user determination unit 507 determines that the user who performed the operation was user B having the user access control 1001.

Next, in step S905, the user access authority management unit 509 determines whether user B is a user who has a sufficient access authority for the hot folder HFA. In the present exemplary embodiment, the access authority for the hot folder HFA is the initial state i.e., full control. Therefore, the user access authority management unit 509 determines that the access authority is sufficient (“YES” in step S905), and the processing proceeds to step S907.

On the other hand, if the user access authority management unit 509 determines that the access authority is not sufficient (“NO” in step S905), the processing proceeds to step S906. In step S906, the error notification processing unit 512 sends an error message to the operating user that they lack access authority, and ends the processing. This notification is different depending on the access method. For notification from the PC, the message is sent to the browser. For notification from the operation unit, the error message is displayed on the operation unit.

Next, in step S907, the mismatch processing determination unit 510 confirms the functions which are restricted for the user based on the user access control function and the function to be used by the process associated with the folder. In the present exemplary embodiment, the mismatch processing determination unit 510 receives information about the function to be used by the processing of the function flow associated with the hot folder A, from the function flow management unit 504. In addition, the mismatch processing determination unit 510 also receives information about the functions restricted by the user access control management unit 508 based on the user access control function.

Next, in step S908, the mismatch processing determination unit 510 determines whether a mismatch occurs, since there is a process which used the restricted function in the information confirmed in step S907. In the present exemplary embodiment, there is no problem between the sending mail prohibition of the user access control 1001 and the process for registering in the hot folder HFB of the process 1002 for the hot folder HFA. Therefore, the mismatch processing determination unit 510 determines that there is no mismatch (“NO” in step S908).

On the other hand, in step S908, if the mismatch processing determination unit 510 determines that a mismatch does occur (“YES” in step S908), the processing proceeds to step S909. In step S909, the user access authority change unit 511 changes the access authority for the hot folder HFA for which information was received from the mismatch processing determination unit 510 that there is a mismatch. The access authority in the changed hot folder HFA is stored in the user access authority management unit 509.

As an example, a case will be described in which sending mail, which is prohibited by the user access control 1001, is included in the function flow processing associated with the hot folder HFA. In this case, the user access authority management unit 509 receives information from the mismatch processing determination unit 510 that there is a mismatch. Thus, the user access authority management unit 509 rescinds (changes) the registration access authority in order to prohibit the registration operation in the hot folder HFA.

In step S910, since the access authority was changed in step S909, the mismatch processing determination unit 510 again determines whether a mismatch occurs in the operation request to the hot folder HFA of user B.

While the following processing is not carried out in the present exemplary embodiment, if the operated access authority is changed, this causes an operation of a hot folder HFA of which access authority was rescinded, thereby causing an error (YES in step S910). Thus, in step S911, the error notification processing unit 512 sends an error to such effect to the user, and ends the present processing.

On the other hand, in step S910, if the mismatch processing determination unit 510 determines that there is no problem in the access authority (“NO” in step S910), the processing returns to step S912.

Then, in step S912, the file/data is registered in the hot folder HFA, and the hot folder control unit 502 execute the function flow stored in the function flow management unit 504.

In the present exemplary embodiment, the hot folder control unit 502 executes the process for registering the file/data in the associated hot folder HFB.

Next, in step S913, the hot folder control unit 502 determines whether the function flow executed in step S912 is finished, namely, determines whether there is any non-completed processing. First, in the initial processing flow, it is determined that there is non-completed processing (“YES” in step S913), and thus the processing proceeds to step S915.

On the other hand, if the hot folder control unit 502 determines that all the processing was executed without an error (“NO” in step S913), the processing proceeds to step S914. In step S914, the hot folder control unit 502 ends the hot folder processing normally, and the present processing is finished.

In step S915, the hot folder control unit 502 continues to execute the function flow executed by the operation of the hot folder. Consequently, in the present exemplary embodiment, the file/data is registered in the hot folder HFB from the hot folder HFA. In the hot folder HFB, the above-described processing is performed from step S901.

Next, in step S916, the hot folder control unit 502 determines whether an error occurred in the processing of the function flow executed by operation of the hot folder. If the hot folder control unit 502 determines that no error occurred (“NO” in step S916), the processing returns to step S913. In the present exemplary embodiment, while similar processing is running on the hot folder HFB, a mismatch occurs in step S908 in the hot folder HFB, and the access authority is changed in step S909 for the hot folder HFB.

Further, when the access authority is changed for the hot folder HFB, an error message is sent by the error notification processing unit 512 that access is not allowed.

If the image processing apparatus has both the hot folder HFA and the hot folder HFB, the error notification processing unit 512 can be shared. Further, if the image processing apparatuses having the hot folder HFA and the hot folder HFB are different, communication can be performed using a communication unit via a network.

Next, in steps S917 and S919, the hot folder control unit 502 determines the type of error which was determined to be present in step S916. First, in step S917, the hot folder control unit 502 determines whether there is any coordinated processing, such as entering data into a separate folder, in the function flow executed by operation of the hot folder. In the present exemplary embodiment, since an operation for registering in the hot folder HFB from the hot folder HFA is performed, the hot folder control unit 502 determines that there is coordination (“YES” in step S917).

On the other hand, in step S917, if the hot folder control unit 502 determines that there is no coordination (“NO” in step S917), this means that an error occurred which is different from an error according to the present invention, such as in the access control or the access authority. Consequently, the processing proceeds to step S918. In step S918, the error notification processing unit 512 sends an error message, and ends the present processing.

However, in step S917, if the hot folder control unit 502 determines that there is coordination (“YES” in step S917), the processing proceeds to step S919. In step S919, since it was learned from the determination in step S917 that there is coordination with another folder, the hot folder control unit 502 determines whether there is an error due to a change in the access authority for the other end.

In the present exemplary embodiment, in the operation for registering in the hot folder HFB from the hot folder HFA, a mismatch occurs in the function flow with the access control of user B on the hot folder HFB side. Consequently, the access authority is changed, thus causing an error to occur, whereby the access authority for the hot folder HFB of the coordination destination is denied. Therefore, in step S919, the hot folder control unit 502 determines that the access authority of the coordination destination is insufficient (“NO” in step S919), and the processing proceeds to step S921.

On the other hand, in step S919, if the hot folder control unit 502 determines that the access authority is sufficient (“YES” in step S919), the processing proceeds to step S920. In step S920, since the error occurred which is different from that according to the present invention, such as in the access control or the access authority, the error notification processing unit 512 sends an error message, and ends the present processing.

In step S921, since it was determined in step S919 that the access authority of the coordination destination hot folder is insufficient (“NO” in step S919), the hot folder control unit 502 also changes the access authority of the operated original hot folder HFA so that a mismatch does not occur.

In the present exemplary embodiment, in the function flow executed by the hot folder HFA, since there is a process which used a restricted function in the operation in the hot folder HFB, the access authority of the hot folder HFA is also changed. Further, in the present exemplary embodiment, a process for sending mail, which is prohibited by the hot folder HFB, is performed by a registration operation for the hot folder HFA. Therefore, the hot folder control unit 502 rescinds (changes) the registration access authority for the hot folder HFA.

Next, in step S922, since an error occurs due to accessing the hot folder of the coordination destination for which access authority was rescinded, the error notification processing unit 512 sends an error message, and ends the present processing.

In the present exemplary embodiment, the error notification processing unit 512 in the hot folder HFA receives an error notification process from the error notification processing unit 512 in the hot folder HFB. Further, the error notification processing unit 512 in the hot folder HFA sends an error message to user B, who operated the hot folder HFA.

Consequently, the access authority state of the hot folder illustrated in FIG. 10 is changed to the access authority state of the hot folder illustrated in FIG. 11.

As illustrated in FIG. 11, in the present exemplary embodiment, based on a series of operations according to the function flow illustrated in FIG. 9, an error occurs and the access authority 1005 of the hot folder HFB illustrated in FIG. 10 is changed to an access authority 1105 of the hot folder HFB illustrated in FIG. 11.

This causes the access authority 1003 of the hot folder HFA illustrated in FIG. 10 to change to an access authority 1103 of the hot folder HFA illustrated in FIG. 11. The thus-changed access authority settings are stored in the user access authority management unit 509 of the respective hot folders HFA and HFB, and subsequent access to the hot folder HFA is prohibited.

A plurality of hot folders can be coordinated in the function flow by having the processing of the flowchart illustrated in FIG. 9 in each hot folder.

Further, when there is a mismatch between the user access control and the access authority, the access authority up to the hot folder of the operation source can be rescinded, so that subsequent operation of the file/data in the hot folder for which the expected processing cannot be completed can be prohibited.

A third exemplary embodiment will now be described in which change of the access authority of the hot folder HFA and the hot folder HFB is performed using FIG. 9 as illustrated in the second exemplary embodiment.

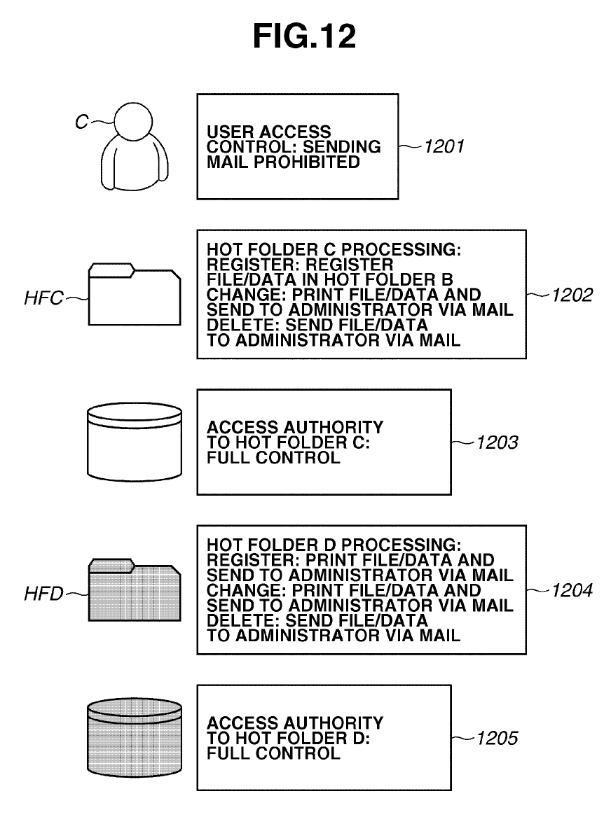

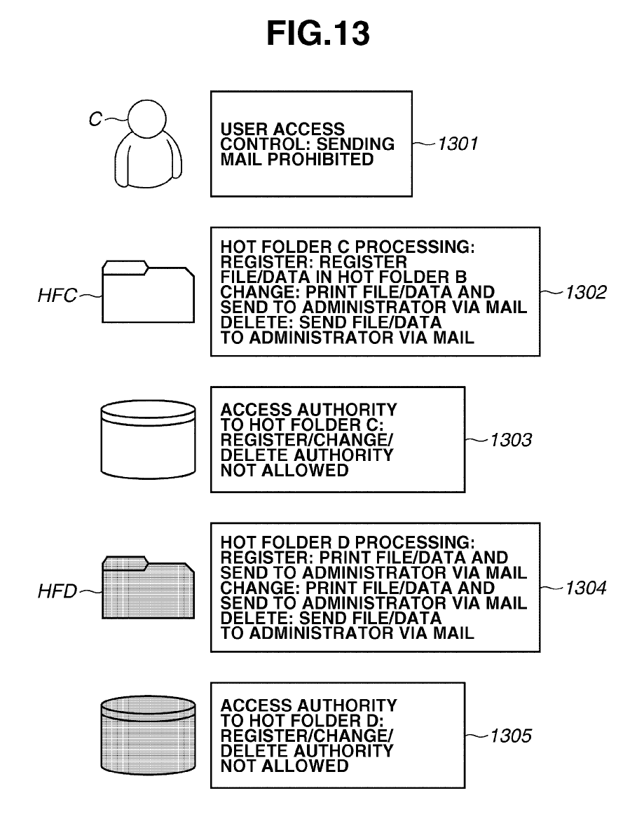

FIGS. 12 and 13 illustrate an access authority state of a hot folder managed by the image processing apparatus according to the present exemplary embodiment. FIGS. 12 and 13 illustrate the set state of a given user C, a hot folder HFC, the access authority for the hot folder HFC, a hot folder HFD, and the access authority for the hot folder HFD. FIG. 12 corresponds to the state before the access authority is rewritten. FIG. 13 corresponds to the state after the access authority for user C has been changed based on the execution illustrated in FIG. 9.

In the third exemplary embodiment, the hot folder processes are divided into more types as compared with the second exemplary embodiment.

Further, the access control for user C is set as indicated by a user access control 1201. Moreover, a process 1202 of the hot folder HFC is associated with the hot folder HFC to be used here, and an access authority 1203 for the hot folder HFC is set to full control without any particular prohibitions.

Similarly, a process 1204 of the hot folder HFD is associated with the hot folder HFD to be used here, and an access authority 1205 for the hot folder HFD is set to full control without any particular prohibitions.

Further, the process 1202 of the hot folder HFC is managed in the function flow management unit 504 of the hot folder HFC.

In addition, the access authority 1203 for the hot folder HFC is managed in the user access authority management unit 509 of the hot folder HFC.

Similarly, the process 1204 of the hot folder HFD is managed in the function flow management unit 504 of the hot folder HFD.

Further, the access authority 1205 for the hot folder HFD is managed in the user access authority management unit 509 of the hot folder HFD.

In an example to be described here, each image processing apparatus is managed individually.

However, the management of each image processing apparatus may also be performed in an integrated manner with an external server. Moreover, management of the respective image processing apparatuses may be performed in a shared manner with a separate image processing apparatus connected via a communication unit such as a network.

The processing in the present exemplary embodiment is similar to the processing performed in the respective steps illustrated in FIG. 9. The difference is that, in addition to the processing performed in the second exemplary embodiment, the present exemplary embodiment is directed to the processing of the hot folder which is performed differently for each type of operation. The steps which are different from the second exemplary embodiment will now be described.

In step S907, the hot folder control unit 502 confirms the process associated with the hot folder for each operation. While in the second exemplary embodiment there was one process associated with the hot folder, in the present exemplary embodiment, there is a plurality of processes associated with the hot folder. Therefore, the function flow and user access control for all operations are checked.

While there was only one associated process in the second exemplary embodiment, in the present exemplary embodiment, three processes are performed. However, the processing itself of the present embodiment is similar to the second exemplary embodiment. Further, the presence of a mismatch is determined for each operation. Then, in step S909, the user access authority change unit 511 changes the access authority for the operations for which a mismatch occurred.

In the present exemplary embodiment, in step S908, the mismatch processing determination unit 510 determines that there is a mismatch in the change and delete operations (“YES” in step S908).

This is because, as indicated by the user access control 1201 illustrated in FIG. 12, the user is prohibited from performing the sending mail function, so that the processing for sending mail which is prohibited by the change and delete operations as indicated by the process 1202 of the hot folder HFB is included.

Therefore, the user access authority change unit 511 in the hot folder HFC rescinds (changes) the change and delete access authority.

Further, in step S910, in the present exemplary embodiment, since there is a plurality of function flows associated with the hot folder, some access authorities are unchanged. Therefore, the mismatch determination is performed again.

For example, in the above-described flow, the hot folder HFC was changed to an access authority prohibiting change and delete. However, the function flow associated with the registration operation indicated by the process 1202 of the hot folder HFC does not have the prohibited sending mail function.

Therefore, since the registration access authority is not rescinded, and no problems occur in the mismatch determination (“NO” in step S910), in step S912, the processing can return to the original execution flow. Ultimately, similar to the second exemplary embodiment, since an error in the access authority occurs for the hot folder HFD of the registration destination, the registration access authority for the hot folder HFD is also rescinded. The specific example is overall the same as the second exemplary embodiment.

In the present exemplary embodiment, as the hot folder HFC and the hot folder HFD, the hot folders may be present in the same image processing apparatus or in different image processing apparatuses.

Thus, the set state of the user, the changed hot folder HFC, and the changed hot folder HFD is changed to the state illustrated in FIGS. 12 and 13.

In the present exemplary embodiment, based on a series of operations according to the function flow illustrated in FIG. 9, an error occurs and the access authority 1205 of the hot folder HFD illustrated in FIG. 12 is changed to an access authority 1305 of the hot folder HFD illustrated in FIG. 13. As a result, the access authority 1203 of the hot folder HFC illustrated in FIG. 12 changes to an access authority 1303 of the hot folder HFD illustrated in FIG. 13. These changed settings are stored in the user access authority management unit 509 in each hot folder, and subsequent access to the hot folder HFC is prohibited.

A plurality of hot folders can be coordinated in the function flow by having the processing illustrated in FIG. 9 in each hot folder.

Further, when there is a mismatch between the user access control and the access authority, the access authority up to the operation source hot folder can be rescinded, so that subsequent operation of the file/data in the hot folder for which the expected processing cannot be completed can be prohibited.

Based on the above, when a process using a function which is restricted by the user access control function is associated with a hot folder, the access authority for the process can be automatically changed.

Therefore, conventional mismatches can be resolved by ensuring that a user cannot use a restricted function because a hot folder operation cannot be performed. Further, by automatically changing the access authority, the burden placed on the administrator to manage the system can be reduced.

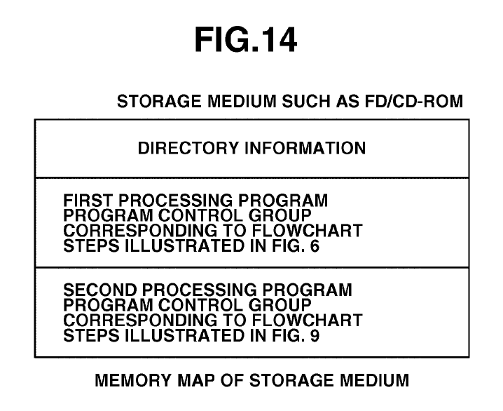

A configuration of the data processing program which can be read by the image processing apparatus according to the present invention will now be described with reference to the memory map illustrated in FIG. 14.

A configuration of the data processing program which can be read by the image processing apparatus according to the present invention will now be described with reference to the memory map illustrated in FIG. 14.

While not specifically illustrated, information for managing a program group stored in the storage medium, for example, version information or the name of a creator, may also be stored. Furthermore, information based on the OS and the like on the program reading side, for example, an icon which displays the program so that it can be identified, can also be stored.

Further, data subordinate to the respective programs is also managed in the above-described directory. In addition, a program for installing the respective programs in a computer, and if the program to be installed is compressed, a decompressing program and the like may also be stored.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-004329 filed Jan. 13, 2009, which is hereby incorporated by reference herein in its entirety.

What is claimed is:

1. An image processing apparatus configured to manage a folder with which a function process to be executed using any of a plurality of function processing units is associated, comprising:
an access control management unit configured to manage a restricted function process for which usage is restricted, for each user, among function processes performed by the plurality of function processing units;
an authority management unit configured to manage an access authority set in the folder for each user;
a change unit configured to, when a file operation on the folder is performed by a user, compare the function process associated with the folder and the restricted function process of an identified user, and change the access authority managed by the authority management unit to match the restricted function process; and
a control unit configured to control a request of the file operation based on the access authority managed by the authority management unit when a file operation is received for the folder from the user.

2. The image processing apparatus according to claim 1, wherein the change unit further comprises a notification unit configured to notify an identified user that the access authority is changed by the change unit and the control unit cannot execute the file operation request.

3. The image processing apparatus according to claim 1, wherein the function process associated with the folder includes a function process which is coordinated with another folder.

4. The image processing apparatus according to claim 3, wherein the access authority of the folder with which the function process using the other folder is associated is also changed when the change unit changes the access authority of the other folder.

5. A method for processing an image in an image processing apparatus configured to manage a folder with which a function process to be executed using any of a plurality of function processing units is associated, comprising:
performing access control management to manage a restricted function process for which usage is restricted, for each user, among the function processes performed by the plurality of function processing units;
performing authority management to manage an access authority set in the folder for each user;
changing the access authority managed by the authority management to match the restricted function process by comparing the function process associated with the folder and the restricted function process of an identified user when a file operation on the folder is performed by a user; and
controlling a request of the file operation based on the access authority managed by the authority management when a file operation is received for the folder from the user.

6. The method for processing an image according to claim 5, comprising notifying an identified user that the access authority is changed and the control step cannot execute the file operation request.

7. The method for processing an image according to claim 5, wherein the function process associated with the folder includes a function process which is coordinated with another folder.

8. The method for processing an image according to claim 5, wherein the access authority of the folder with which the function process using the other folder is associated is also changed when the access authority of the other folder is changed.

9. A computer-readable storage medium storing a program to execute in a computer the method for processing an image according to claim 5.
